(19) United States
(12) Patent Application Publication
(10) Pub. No.: US 2002/0014949 A1
(43) Pub. Date: Feb. 7, 2002

(54) Chip component

(75) Inventors: Hirotoshi Tanaka, Tokyo (JP); Masataka Kohara, Tokyo (JP); Hideya Maki, Tokyo (JP)

Correspondence Address: LOWE HAUPTMAN GILMAN & BERNER, LLP, 1700 Diagonal Road, Suite 310, Alexandria, VA, 22314, US

(73) Assignee: TAIYO YUDEN CO., LTD

(21) Appl. No.: 09/956,132

(22) Filed: Sep. 20, 2001

Related U.S. Application Data
(62) Division of application No. 08/942,722, filed on Oct. 2, 1997.

(30) Foreign Application Priority Data
Oct. 4, 1996 (JP) H8-264675

(51) Int. Cl. H01C 1/012

(52) U.S. Cl. 338/313

(57) ABSTRACT

A chip component such as chip resistor, which is capable of being mounted obversely or reversely to a substrate or the like. Since the color of the armor is adjusted so as to be green identical with that of a ceramics chip, the lightness distribution of the component front face is similar with that of the component back face. Therefore, there is no case that chip component mounted obversely and chip component mounted reversely are identified as different components in a testing step of detecting a positional deviation or unloaded component by a color or monochromatic image processing (digital image processing), even if the component is mounted reversely to a substrate or the like.

### BACKGROUND OF THE INVENTION

1. Field of the Invention

The present invention relates to a chip component, such as chip resistor.

2. Description of the Prior Art

Among the chip components capable of being fed by means of a chip component feeder such as a bulk feeder, as a chip component allowed to load obversely or reversely on a substrate or the like, the following chip resistor is known.

This chip resistor comprises an insulating ceramics chip having a flat prism shape, a resistor film formed at the center on the front face (one of the two largest-area faces) of a ceramics chip, a pair of lead electrodes formed on both ends in length of front face of the ceramics chip and connected to the ends of the above resistor film, a pair of external electrodes formed on both ends in length of front face of the ceramics chip so as to extend to front face, end faces and back face and connected to the ends of the lead electrodes, and an armor covering an exposed portion of the resistor film.

When said ceramics chip is made of alumina, the resistor film is made of ruthenium oxide and the armor is made of transparent or translucent glass or resin, the color of a portion other than the external electrodes on the back face of component becomes white because the ground color of alumina is white, whereas that of a portion other than the external electrodes on front face of component becomes black because the ground color of ruthenium oxide is black and this color emerges to the surface through the armor.

In other words, because the pair of external electrodes are exposed both on the front face and the back face, said chip resistor can be mounted obversely or reversely to a substrate or the like regardless of the presence or absence of an armor and no particular inconvenience occurs functionally even if packaged reversely. Because of the difference in the color (black) appearing through the armor and the ground color (white) of the ceramics chip, a difference in distribution of lightness occurs between the front face and the back face of component.

A chip component including the chip resistor mentioned above are packaged on a substrate or the like generally through a mounting step, a testing step and a joining step. In the testing step, a testing device (digital image processing device) for detecting the positional deviation or an unmounted component by a color or monochromatic image processing is generally employed and mounted component is subjected to a predetermined test through image pickup, data processing and quality testing steps.

However, since arrangement is difficult in matching the direction of the faces prior to the mounting step, chip component capable of being mounted obversely or reversely to the substrate or the like as with the chip resistor mentioned above might be mounted reversely to the substrate or the like and might end in joining together without being corrected.

As mentioned above, though no particular inconvenience occurs functionally even if the chip component is mounted reversely, but in the case of such chip component as the above-mentioned chip resistor where the lightness distribution is different between the front face and the back face of the chip component, inconveniences that a chip component mounted obversely and a chip component mounted reversely are identified as different components, a so-called identification error occurs due to the difference in lightness distribution between the front face and the back face in executing a testing step based on the image processing.

On the other hand, in the case of chip component where the external electrodes are connected to the lead electrodes as with said chip resistor, the smaller the size of component is, the more difficult it becomes to secure a sufficient connection area for the lead and the external electrodes. Especially, in the case of a structure which connects the external electrodes only to the end edges of the lead electrodes, an extreme decrease in the connection area between the lead and the external electrodes is likely to cause a connection failure between them.

### SUMMARY OF THE INVENTION

The present invention was made in consideration of the above-mentioned circumstances, while a first object thereof relates to chip component such as chip resistor capable of being mounted obversely or reversely to a substrate or the like and is to provide chip component enabling to prevent the identification of chip component mounted obversely and chip component mounted reversely as different ones during a testing step by the image processing.

To achieve the first object, the present invention is characterized in that the lightness distribution on the front face has similarity with the lightness distribution on the back face of chip component capable of being mounted obversely or reversely to the substrate or the like.

A second object relates to chip component such as chip resistor in which an external electrode is connected to the end edge of a lead electrode and is to provide chip component capable of securing a sufficient connection area for the lead and the external electrodes, thus enabling the connection between them to be well performed even if the size of component becomes small.

To achieve the second object, the present invention is characterized in that, in chip component having a structure that the edge of the lead electrode is exposed on the end face of a ceramics chip and the external electrode is connected to the edge thereof, a connection aid member extending along the end face of the ceramics chip from the edge is formed on the lead electrode and is used to connect the lead electrode and the external electrode.

The above and other objects, aspects, features and advantages of the present invention will become apparent from the following detailed description in conjunction with the appended claims.

### BRIEF DESCRIPTION OF THE DRAWINGS

FIGS. 1 (a) and 1 (b) are a top view showing an embodiment of the present invention applied to a chip resistor and a sectional view taken along line b-b thereof;

FIG. 2 to FIG. 9 are drawings showing a method for manufacturing the chip resistor shown in FIG. 1;

FIGS. 10 (a), 10 (b), 10 (c) and 10 (d) are an external perspective view, a vertical section and enlarged vertical sections in the principal part showing another embodiment of the present invention applied to the chip resistor; and

FIG. 11 to FIG. 18 are drawings showing a method for manufacturing the chip resistor shown in FIG. 10;

FIGS. 19 (a) and 19 (b) are drawings showing two modified aspects of the chip resistor shown in FIG. 10.

### DESCRIPTION OF THE PREFERRED EMBODIMENTS

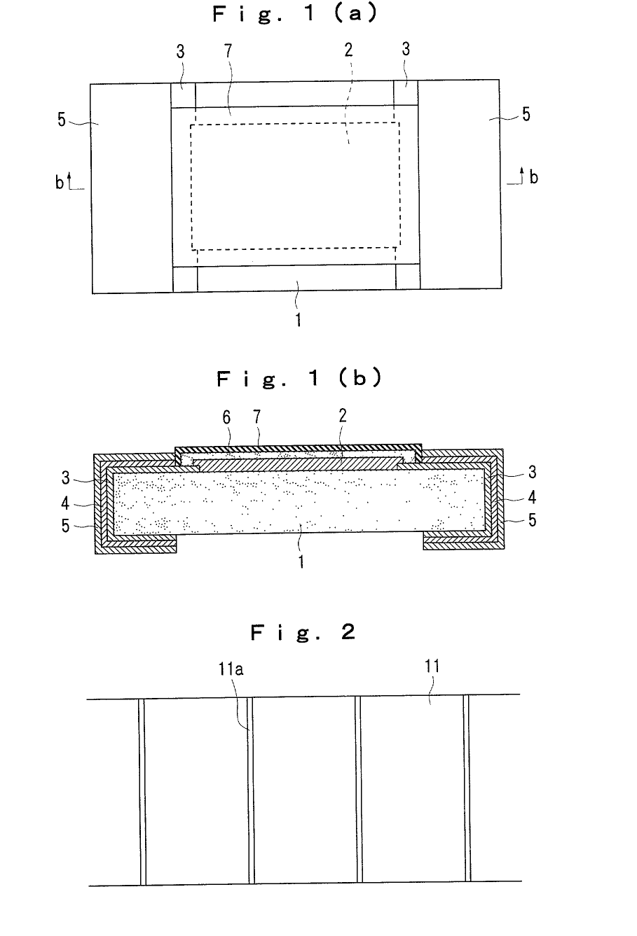

FIGS. 1 and 9 show a preferred embodiment of the present invention applied to a chip resistor.

FIGS. 1 (a) and 1 (b) are a top view of a chip resistor and a sectional view taken along line b-b thereof. As shown in FIG. 1 (a), the chip resistor comprises a ceramics chip 1, a resistor film 2, a pair of lead electrodes 3, a pair of nickel films 4, a pair of solder films 5, a glass film 6 and a resin film 7. In this chip resistor, an armor of two-layer structure is formed of a glass film 6 and a resin film 7 and an external electrode is formed of a nickel film 4 and a solder film 5.

The ceramics chip 1, made of a porcelain composition burned at low temperature (burning temperature: not higher than 1000° C.) which contains 25-60 wt % Al₂O₃, 10-40 wt % SiO₂, 3-30 wt % B₂O₃, 1-15 wt % MgO, 0.2-10 wt % Cr₂O₃, 0.1-3 wt % Li₂O and 1-20 wt % of at least one selected from CaO, SrO and BaO, has a high insulating property. This ceramics chip 1 has a shape of a flat prism and has the ground color of green because of containing Cr₂O₃ as a material.

The resistor film 2 is made of ruthenium oxide, and is formed in a rectangular viewed from the above at the center of the front face of the ceramics chip 1 (one of two largest-area faces). The resistor film 2 has the ground color of black because it is made of ruthenium oxide.

The lead electrodes 3, made of silver or its alloy, are so formed as to extend to the front face, the end faces and the back face at both ends in length of the above ceramics chip 1 and connects the respective ends on the front face side to the corresponding ends in length of the resistor film 2.

The nickel films 4, made of nickel or its alloy, are so formed as to cover the above lead electrodes 3.

The solder films 5, made of Sn—Pb alloy, are so formed as to cover the above nickel films 4.

The glass film 6, made of a glass material mainly composed of lead boro-silicate and Si₂O₃ and containing 50 wt % of the same porcelain composition powder as with the above ceramics chip 1, is so formed as to cover the above resistor film 2. As with the above ceramics chip 1, this glass film 6 has the ground color of green because of containing Cr₂O₃ as a material.

The resin film 7, made of a resin material mainly composed of epoxy resin and containing 50 wt % of the same porcelain composition powder as with the above ceramics chip 1, is so formed as to cover the glass film 6. As with the above ceramics chip 1, this resin film 7 has the ground color of green because of containing Cr₂O₃ as a material.

In other words, by making the same porcelain composition powder as with the above ceramics chip 1 to be contained as coloring matter in a transparent or a translucent glass film 6 and resin film 7, the color of the armor (glass film 6 and resin film 7) is adjusted in such a manner as to become green similar to that of the ceramics chip 1. Accordingly, even if the ground color of the resistor film 2 is black, this color never emerges through the armor.

The above-mentioned chip resistor is so structured that both the resin film 7 constituent of the armor and the ceramics chip 1 are exposed on the portion other than the external electrode of the front face (face on the side of a resistor film) and the ceramics chip 1 is exposed on the portion other than the external electrode of the chip back face (face on the opposite side of a resistor film), but as mentioned above, the color of the front face and that of the ceramics chip 1 are so arranged as to be similar with each other and consequently the component front face and the component back face becomes similar in lightness distribution.

Incidentally, the similarity in lightness distribution here means the inclusion within the tolerance of lightness recognition in the image processing but does not refer to a complete coincidence.

Like a conventional chip component, the chip resistor shown in FIG. 1 is packaged to the substrate or the like through a mounting step, a testing step and a joining step. For the testing step, a testing device (digital image processing device) for detecting the positional deviation or an unmounted component by a color or monochromatic image processing is generally employed and the mounted component is subjected to a predetermined test through image pickup, data processing, quality testing steps.

Meanwhile, since arrangement is difficult in matching the direction of the faces prior to the mounting step, chip component capable of being mounted obversely or reversely to the substrate or the like as with the chip resistor mentioned above might be mounted reversely to the substrate or the like and might end in joining together without being corrected.

With the above chip resistor, however, since the lightness distribution on the front face and the lightness distribution on the back face of the chip component are made similar within the tolerance of lightness recognition in the image processing, there occurs no trouble that chip component mounted obversely and chip component mounted reversely are identified as different components in the testing step of detecting the positional deviation or an unmounted component by a color or monochromatic image processing (digital image processing), even if the component is mounted reversely to the substrate or the like.

Thus, unlike a conventional chip component, a problem of identification error that has been caused by the difference in lightness distribution between the front face and the back face of the chip component can be surely avoided and the testing step can be carried out without a hindrance.

Moreover, since chip component mounted obversely and chip component mounted reversely have a similar color tone, even a mixture of components mounted in opposite directions would bring about no poor appearance.

Furthermore, since powder of the same porcelain composition as the ceramics chip 1 is utilized as coloring matter, no trouble is taken to separately prepare other coloring matters and the color of an armor be equated to that of the ceramics chip by a simple technique.

Hereinafter, referring to FIG. 2 to FIG. 9, a preferable method for manufacturing the chip resistor shown in FIG. 1 will be described.

First, an insulating substrate 11 of a predetermined width is prepared which has parallel separating grooves 11a in length at predetermined intervals as shown in FIG. 2.

This substrate 11 is prepared through a step of mixing Al₂O₃ powder, SiO₂ powder, B₂O₃ power, MgO powder, Cr₂O₃ powder, Li₂O powder, and further at least any one of powder of CaO, SrO and BaO at a predetermined weight ratio and adding a binder and a solvent to this powder mixture to make a slurry, a step of coating the slurry to a predetermined thickness by the doctor blade process to obtain a sheet, a step of forming grooves in the sheet and then cutting the sheet in a direction right-angled thereto to obtain a strip sheet of a predetermined width and a step of burning the strip sheet at 850-1000° C. for a predetermined period of time. In addition to a method for forming grooves serving as separating grooves 11a by a technique such as pressing the unburned sheet mentioned above, a forming method by grinding after burning the strip sheet mentioned above may be adopted.

Then, as shown in FIG. 3, a lead electrode 12 is formed along the side edges on both sides in width of the substrate 11. These lead electrodes 12 are formed by coating an electrode paste, prepared by adding a binder and a solvent to powder of silver or its alloy, onto both sides in width of the substrate 11 at a predetermined size and width by a thick-film forming technique such as dip or roller coating, and hardening it by the heating treatment. Needless to say, these lead electrodes 12 can be formed also by using a thin-film forming technique such as evaporation and sputtering while masking the unnecessary portions.

Then, as shown in FIG. 4, a resistor film 13 is formed in each region enclosed by the separating grooves 11a on one face of the substrate 11 in such a manner that both ends overlap on the lead electrodes 12. These resistor films 13 are formed by coating an resistor paste, prepared by adding a binder and a solvent to powder of ruthenium oxide, onto one side at a predetermined position of the substrate 11 in a predetermined shape and thickness by a technique such as screen printing, and hardening it by the heating treatment. Needless to say, these resistor films 13 can be formed also by using the thin-film forming technique such as evaporation and sputtering while masking the unnecessary portions.

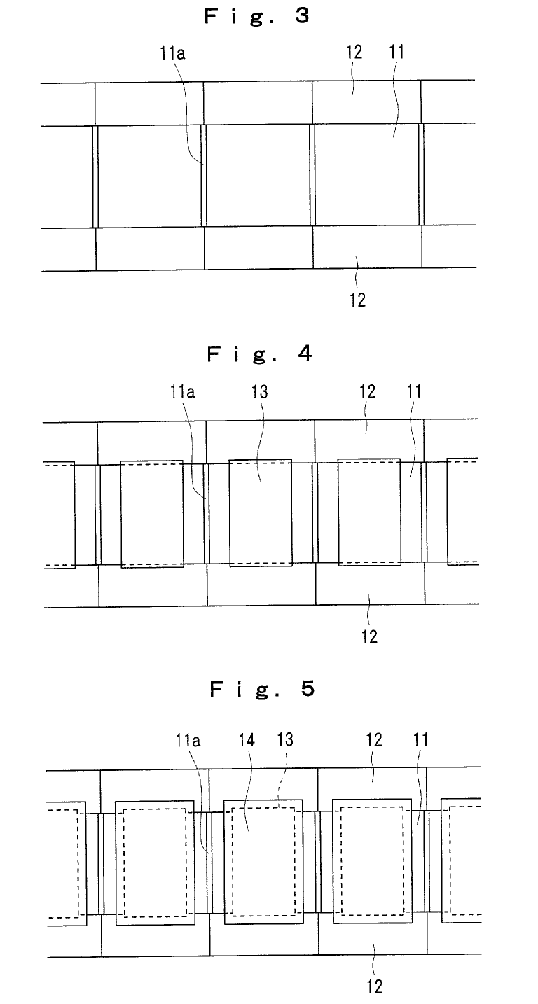

Then, as shown in FIG. 5, a glass film 14 is formed on one face of the substrate 11 so as to cover each resistor film 13. These resistor films 14 are formed by coating a glass paste, prepared by adding a binder and a solvent to a powder mixture of powder of lead boro-silicate and Si₂O₃ with the same porcelain composition powder as with the substrate 11, onto one side at a predetermined position of the substrate 11 in a predetermined shape and thickness by a technique such as screen printing, and hardening it by the heating treatment. Incidentally, the powder of the above porcelain composition can be easily obtained by pulverizing the same material as with the substrate 11.

Then, as shown in FIG. 6, trimming is effected by irradiating a laser beam in the IR region to each resistor film 13 from over the glass film 14 while detecting a value of resistance with a detecting terminal kept in contact with the lead electrodes 12, thus fulfilling the micro-tuning of a value of resistance with a groove 15 formed in each resistor film 13.

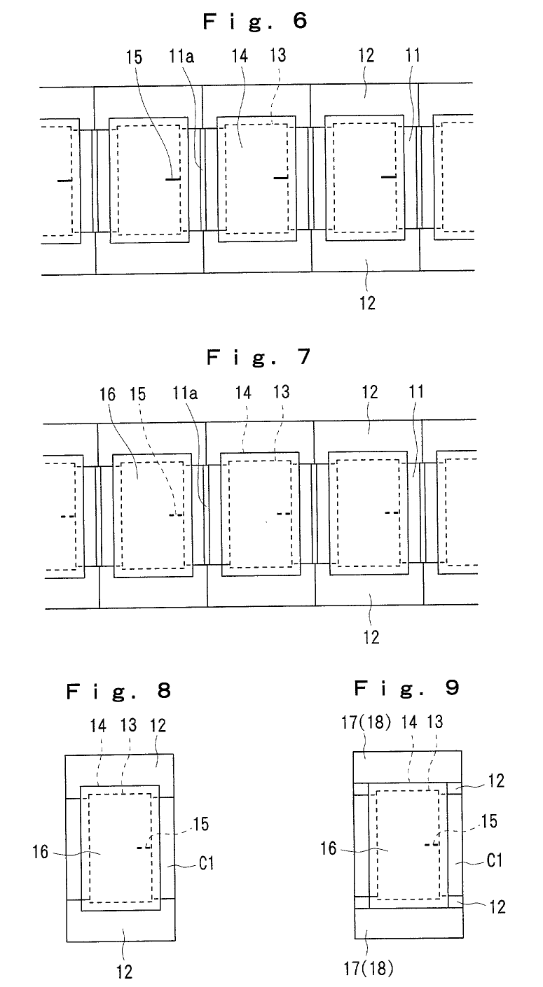

Then, as shown in FIG. 7, a resin film 16 is formed on one face of the substrate 11 so as to cover each glass film 14. These resin films 16 are formed by coating a resin paste, prepared by adding the same porcelain composition powder as with the substrate 11 to a fluid of epoxy resin, onto one side at a predetermined position of the substrate 11 in a predetermined shape and thickness by a technique such as screen printing, and hardening it by the heating treatment.

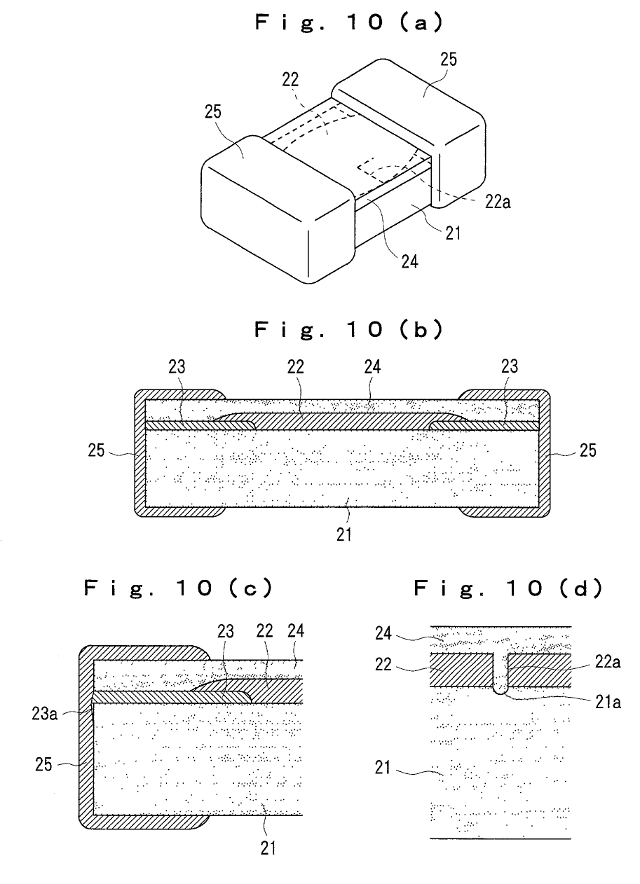

Then, as shown in FIG. 8, the substrate 11 is divided along the separating grooves 11a to prepare unit-shaped ceramics chips C1.

Then, as shown in FIG. 9, a nickel film 17 and a solder film 18 are formed in succession at both ends in length of the ceramics chip C1. These nickel films 17 and solder films 18 are formed by forming thin films in succession on both sides in length of the ceramics chip C1 through the thin-film forming technique such as non-electrolytic plating or electrolytic plating. Needless to say, these nickel films 17 and solder films 18 can be formed through the thick-film forming technique such as dip or roller coating. By such a procedure, the chip resistor shown in FIG. 1 is manufactured.

According to a method for the chip resistor as shown in FIG. 2 to FIG. 9, the color of the glass film 14 constituent of the armor and that of the resin film 16 can be made green identical with that of the substrate 11 by adding the same porcelain composition powder as with the substrate 11 to the glass paste for the glass film 14 and the resin paste for the resin film 16, respectively.

Besides, since greening of the glass film 14 can elevate the absorptivity of the laser beam, the reflection of the laser beam on the glass film 14 is prevented and an efficient laser trimming can be effected even when the laser trimming to the resistor film 13 is performed via the glass film 14.

Furthermore, since a low-temperature burned substrate that can be burned at 1000° C. or lower is employed as the substrate 11, manufacturing of the substrate 11 becomes easy and the manufacturing cost can be reduced.

Meanwhile, in the embodiment shown in FIG. 1 to FIG. 9, component with the armor composed of the glass film and the resin film are exemplified, but both films may be glass or resin and the armor may be a single layer of glass film or resin film if the laser trimming is made directly to the resistor film.

Moreover, a case where the color of both glass and resin film constituent of the armor is made green identical with the ground color of the ceramics chip is exemplified, but the color of the resin film on the front face side alone may be made identical with the ground color of the ceramics chip.

Furthermore, in the embodiment shown in FIG. 1 to FIG. 9, a case where the ground color of the ceramics chip is green is exemplified, but also in a case where the ceramics chip is made of alumina and has a ground color of white and in a case where the ceramics chip has other ground colors than white, a similar effect is obtained if the color of the armor is so adjusted as to match with the relevant ground color.

Still further, in the embodiment shown in FIG. 1 to FIG. 9, a case where the color adjustment is fulfilled by adding the powder of the same material as the ceramics chip or the substrate to a paste for the armor is exemplified, but a similar color adjustment can be made also by adding other coloring matters than the above-mentioned powder to the paste for the armor.

Yet further, in the embodiment shown in FIG. 1 to FIG. 9, a case where the color adjustment is fulfilled by adding the powder of the same material as the ceramics chip or the substrate to the paste for the armor is exemplified, but a similar color adjustment can be made also by coating a paint onto the surface of the armor.

Yet further, in the embodiment shown in FIG. 1 to FIG. 9, component in which the lightness distribution is made similar between the component front face and the component back face is exemplified, but if the hue is identical, no identification error occurs in the testing step based on the color or monochromatic image processing though the saturation differs to some extent, and moreover an outer appearance never deteriorates.

Still further, when the testing device for detecting a positional deviation or unloaded component by the monochromatic image processing, in other words, when the testing device incapable of discriminating the hue is employed in the testing step, it is not always required to match the hue of the armor with that of the ceramics chip, and an identification error can be prevented only by the lightness matching.

Still further, in the embodiment shown in FIG. 1 to FIG. 9, the chip resistor is exemplified as chip component, but if chip component can be mounted obversely or reversely to the substrate or the like, a same effect can be also obtained for any other components than the chip resistor, such as, e.g., chip jumper, chip inductor and chip capacitor.

FIG. 10 to FIG. 18 show another embodiment of the present invention applied to the chip resistor.

FIGS. 10 (a) to 10 (d) are an external perspective view, a vertical section and principal part enlarged vertical sections of the chip resistor. As seen from FIGS. 10 (a) to 10 (d), the chip resistor comprises a ceramics chip 21, a resistor film 22, a pair of lead electrodes 23, an armor 24 and a pair of external electrodes 25.

The ceramics chip 21, made of highly insulating porcelain composition such as alumina, assumes the shape of a flat prism.

The resistor film 22, made of ruthenium oxide, is formed at the center on the front face (one of the two largest-area faces) of the above ceramics chip 21 in such a shape as to gradually increase in width toward the middle in length as viewed from above.

The lead electrodes 23, made of silver or its alloy, are so formed at both ends in length on the front face of the above ceramics chip 21 that the respective ends contact with the corresponding ends in length of the resistor film 22. The armor 24, made of a glass material mainly composed of lead boro-silicate and Si₂O₃ or a resin material mainly composed of epoxy resin, is so formed on the whole front face of the ceramics chip 21 as to cover the above resistor film 22 and the lead electrode 23.

The external electrodes 25, made of nickel or its alloy, are so formed at both ends in length of the ceramics chip 21 as to extend the front face, the end faces, the side faces and the back face.

As shown in FIG. 10 (c), only the end edges of the lead electrodes 23 are exposed on the end faces of the ceramics chip 21. Besides, on the end edges of these lead electrodes 23, connection aid members 23a extending downward along the end faces of the ceramics chip 21 from the relevant end edge are formed. As mentioned later, this connection aid member 23a is a burr generated by a plastic deformation when cutting the lead electrode 23, which is discretely or continuously formed along the end edge of the lead electrode 23 and is adhered to the end faces of the ceramics chip 21. Viz., the lead electrode 23 and the external electrode 25 are connected by using this connection aid member 23a.

Moreover, as shown in FIG. 10 (d), a groove 22a for the adjustment of resistance is formed by the laser trimming on the resistor film 22, a groove 21a continuous therewith is formed on the front face of the ceramics chip 21 situated below and a part of the armor 24 spreads inside the groove 22a of the resistor film 22 and the groove 21a of the ceramics chip 21.

According to the chip resistor shown in FIG. 10, since formed on the end edges of the lead electrodes 23 are the connection aid members 23a extending downward along the end faces of the ceramics chip 21, used to connect the lead electrodes 23 and the external electrodes 25, the area for connection to the external electrodes 25 are fully maintained with the above connection aid members 23a even if the exposed area of the lead electrodes 23 on the end edges is small, thereby enabling the connection failure between the lead electrodes 23 and the external electrodes 25 to be surely prevented.

Besides, since the resistor film 22 is so shaped as to gradually increase in width toward the middle in length, a decrease in the strength of the resistor film 22 due to the formation of the groove 22a can be prevented and the occurrence of a crack due to the decrease in the strength can be in advance avoided if the groove 22a for the adjustment of resistance is so arranged as to be formed at the widest portion. And moreover, since the width of the middle in length is large, the adjustment range of resistance can be taken large in comparison with the resistor film of a rectangular shape.

Furthermore, also on the ceramics chip 21 below the groove 22a for the adjustment of a resistance formed on the resistor film 22, the groove 21a continuous thereto is formed and a part of the armor 24 is allowed to spread inside the groove 22a of the resistor film 22 and the groove 21a of the substrate 21, the part of the armor 24 is used to directly connect the armor 24 with the ceramics chip 21, so that the adhesive strength of the armor 24 and that of the resistor film 22 can be enhanced. Thus, even when the close adhesion between the resistor film 22 and the ceramics chip 21 is difficult to obtain in view of the relation between a material and the size or when the close adhesion between the armor 24 and the resistor film 22 is difficult to obtain, the peeling-off of the resistor film 22 and the armor 24 can be surely prevented.

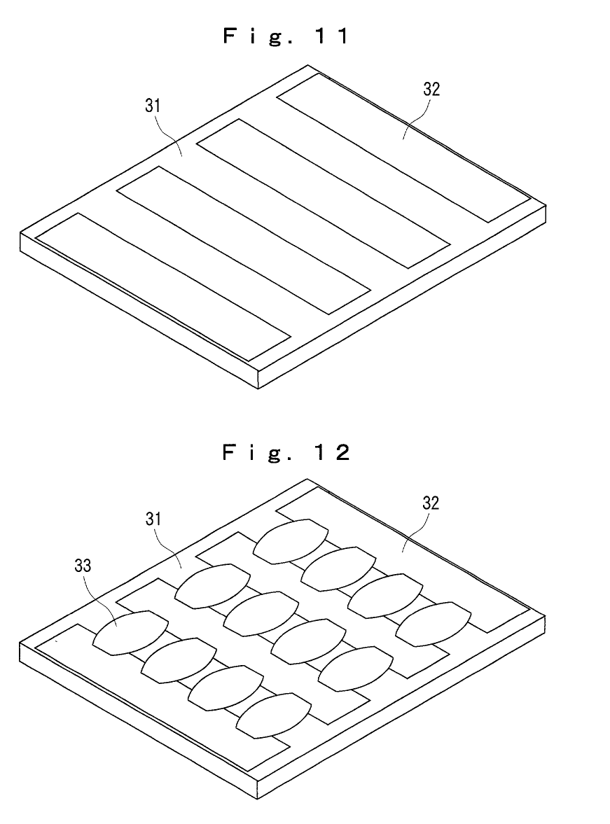

Hereinafter, referring to FIG. 11 to FIG. 18, a preferable method for manufacturing a chip resistor shown in FIG. 10 will be described.

First, an insulating substrate 31 as shown in FIG. 11 is prepared. This substrate 31, made of porcelain composition such as alumina, has an outline size corresponding to a predetermined thickness and number of pieces to be secured. Incidentally, in FIG. 11, one with 12 pieces to be secured is shown for conveniences, but actually, one in which a more pieces can be obtained is employed as the substrate 31.

Then, on the top face of this substrate 31, as shown in FIG. 11, a lead electrode 32 is formed in an arrangement and number corresponding to the number of pieces to be obtained. These lead electrodes 32 are formed by coating an electrode paste, prepared by adding a binder and a solvent to powder of silver or its alloy, onto the surface of the substrate 31 at a predetermined size and thickness by a technique such as screen printing, and hardening it by the heating treatment. Needless to say, these lead electrodes 32 can be formed also by using the thin-film forming technique such as evaporation and sputtering while masking the unnecessary portions.

Then, as shown in FIG. 12, a resistor film 33 is formed on the top face of the substrate 31 with an arrangement and a number corresponding to the number of pieces to be obtained in such a manner that both ends in length overlap on the lead electrode 32. These resistor films 33 are so formed by coating a resistor paste, prepared by adding a binder and a solvent to powder of ruthenium oxide, onto the surface of the substrate 31 through a technique such as screen printing as to gradually increase in width toward the middle in length and hardening it through heating treatment. Needless to say, these resistor films 33 can be formed also by using the thin-film forming technique such as evaporation and sputtering while masking the unnecessary portions.

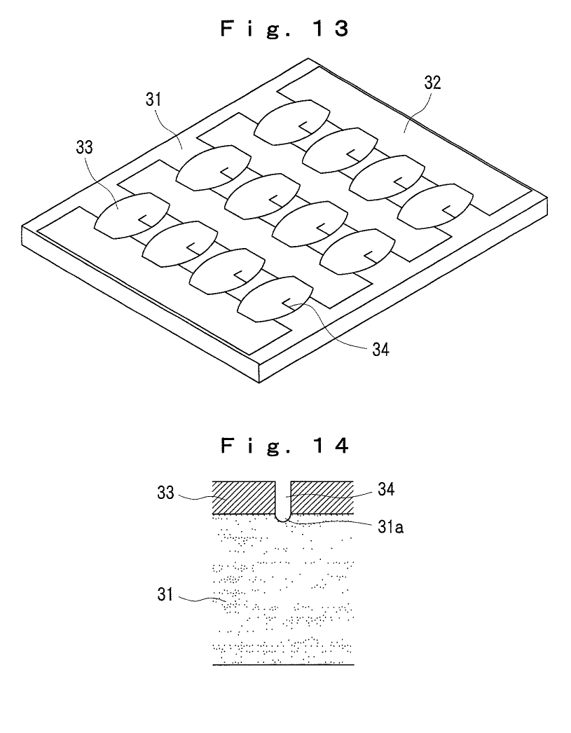

Then, as shown in FIG. 13, trimming is effected by irradiating a laser beam in the IR region to each resistor film 33 while detecting a value of resistance with a detecting terminal kept in contact with the lead electrodes 32, thus fulfilling the micro-tuning of a value of resistance with a groove 34 formed in each resistor film 33.

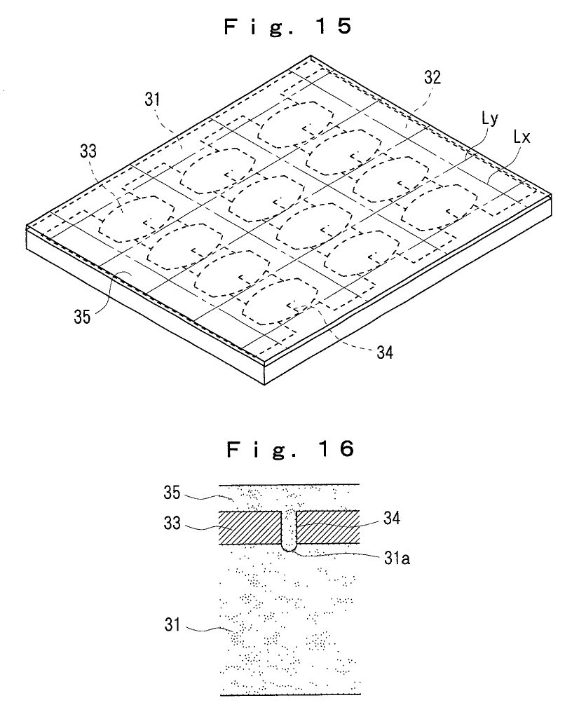

From the standpoint of resistance adjustment, it is only necessary that the groove 34 is formed on the resistor film alone, but here as shown in FIG. 14, the output and the irradiation period of an irradiating laser beam is in advance established through experiments or the like so that a groove 31a can be formed simultaneously also on the substrate 31.

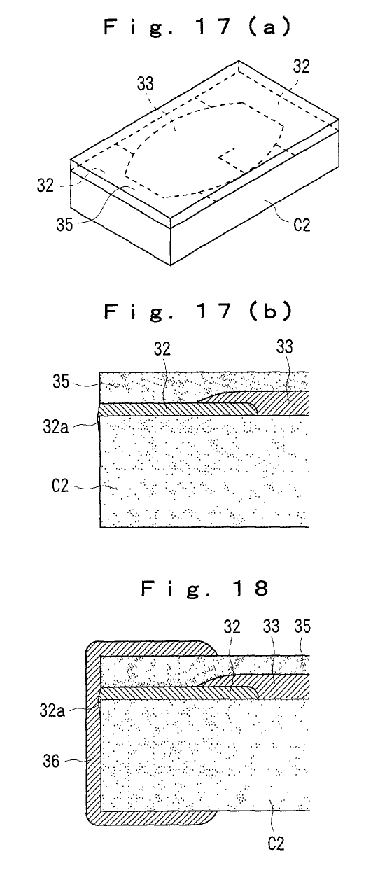

Then, as shown in FIG. 15, an armor 35 is formed on the whole surface of the substrate 31 in a predetermined thickness. This armor 35 is formed by coating a glass paste, prepared by adding a binder and a solvent to powder of lead boro-silicate and Si₂O₃, or a resin past such as epoxy resin onto the whole top face of the substrate 31 by a technique such as screen printing, and hardening it by the heating treatment. In either case, the surface of the armor 35 is made as flat as possible. At the time when this armor 35 is being formed, as shown in FIG. 16, a part of material serving for the armor 35 spreads inside the groove 34 of the resistor film 33 and that 31a of the substrate 31 and is hardened as it stands alone.

Then, by cutting the substrate 31 along the virtual cut lines Lx and Ly designated with a two-point chain line in FIG. 15, unit-shaped ceramics chips C2 as shown in FIG. 17 (a) are formed. For this cutting, a well-known dicing device having a cutting blade such as diamond wheel is utilized. At the time of this cutting, as shown in FIG. 17 (b), a burr (connection aid member) 32a generated due to a plastic deformation when cutting the lead electrode 32 is formed downward along the end faces of the ceramics chip C2 from the lead electrode 32, which sticks to the end faces of the ceramics chip C2.

Then, if necessary, the ceramics chip C2 is subjected to a barrel grinding in a lump of many pieces. By this grinding, corners and ridgelines of the ceramics chip C2 are rounded off while the armor more subject to grinding than the ceramics chip C2 and the lead electrodes 32 are grounded as a whole, so that the exposure of the end edges of the lead electrodes 32 and the above connection aid members 32a becomes apparent.

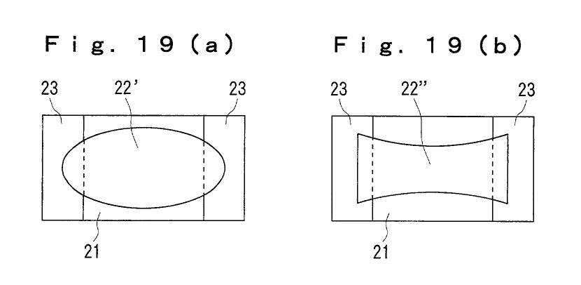

Then, as shown in FIG. 18, external electrodes 36 are formed on both ends in length of the ceramics chip C2. These external electrodes 36 can be formed also by coating an electrode paste, prepared by adding a binder and a solvent to powder of nickel or its alloy, onto both sides in length of the ceramics chip C2 by the thick-film forming technique such as dip or roller coating and hardening it by the heating treatment. Needless to say, these external electrodes 36 can be formed also by using the thin-film forming technique such as non-electrolytic plating or electrolytic plating.

In accordance with the procedure mentioned above, the chip resistor shown in FIG. 10 is manufactured, but if necessary, a solder film may be formed on the surface of the external electrodes 36. Moreover, by repeating a step of forming the armor twice, two-layered armor, e.g., an armor comprising a glass film in the lower layer and a resin film in the upper layer, may be formed.

According to a method for manufacturing the chip resistor as shown in FIG. 11 to FIG. 18, since individual chips are obtained by cutting after the armor 35 is formed over the whole surface, a bulge formed on the armor due to a surface tension is prevented like the forming of the armor in the unit of a resistor film and the armor 35 having a flat surface can be formed on the resistor film 33, so that this flat surface can be put to use for a well and stable component attraction with an attraction nozzle or the like.

Moreover, by cutting the lead electrode 32 together with the substrate 31, expected connection aid members 32a can be simply and exactly formed along the end faces of the ceramics chip C2.

Incidentally, in the embodiment shown in FIG. 10 to FIG. 18, one shape example of the resistor film is shown, but even if the shape of the resistor film assumes a shape (symbol 22′) as shown in FIG. 19 (a), a decrease in the strength of the resistor film which is caused by a groove for the adjustment of a resistance value, and the occurrence of a crack accompanying the decrease in strength can be prevented in advance as shown above.

Moreover, if the resistor film is so shaped (symbol 22″) as to gradually decrease in width toward the middle in length as shown in FIG. 19 (b), an advantage as mentioned above is damaged but on the other hand, since a high value of resistance can be obtained even for a shorter cut groove, the effect of production can be enhanced by shortening a trimming time.

Furthermore, if a substrate having many fine pores is used, the unit weight of the chip resistor can be reduced and moreover the heat generated in the resistor film can be radiated efficiently to suppress a fluctuation in a value of resistance due to heat.

Still further, if a fine roughness is provided on the exposed face of at least either one of the ceramics chip 21 or the armor 22, a surface area increases on account of the roughness, so that the heat generated in the resistor film can be radiated efficiently to suppress a fluctuation in a value of resistance due to heat.

Yet further, in the embodiment shown in FIG. 10 to FIG. 18, the chip resistor is exemplified as chip component, but if the external electrodes are connected to the lead electrodes in chip component, the same effect as shown above can be obtained for any other chip components than the chip resistor such as e.g., chip jumper, chip inductor and chip capacitor.

What is claimed is:

1. A chip component capable of being mounted obversely or reversely to a substrate or the like wherein
a lightness distribution of a component front face and that of a component back face have similarity.

2. A chip component according to claim 1, wherein
the similarity of said lightness distribution is within the tolerance of lightness recognition in the image processing.

3. A chip component according to claim 1, wherein
said lightness distribution is accompanied with a hue.

4. A chip component according to claim 1, having a structure that
an external electrode and an armor at least are exposed to the component front face, and the external electrode and a ceramics chip at least are exposed to the component back face.

5. A chip component according to claim 4, wherein
said armor, made of glass or resin, contains a coloring matter for making its lightness similar with that of the ceramics chip.

6. A chip component according to claim 5, wherein
said coloring matter is powder of the same material as that of said ceramics chip.

7. A chip component according to claim 4, wherein
said armor is made of glass or resin, and onto the surface of said armor, a paint for making its lightness similar with that of the ceramics chip is coated.

8. A chip component according to claim 4, wherein
said ceramics chip and said armor have the hue of green group.

9. A chip component having a structure that the end edge of a lead electrode is exposed to the end face of a ceramics chip and an external electrode is connected to said end edge, wherein
a connection aid member, formed on said lead electrode which extends from its end edge along the end face of said ceramics chip, is used to connect said lead electrode and said external electrode.

10. A chip component according to claim 9, wherein
said connection aid member is formed discretely or continuously along the end edge of said lead electrode.

11. A chip component according to claim 9, wherein
said connection aid member is a burr formed when cutting said lead electrode.

12. A chip component according to claim 9, wherein
a resistor film is formed on said ceramics chip, and is so structured as to gradually increase in width from its end edge toward the middle.

13. A chip component according to claim 12, wherein
a groove for adjusting a value of resistance, formed on said resistor film, extends to the front face of the ceramics chip below and a part of the armor covering the resistor film gets inside the groove of said resistor film and that of said ceramics chip.
